(19) United States
(12) Patent Application Publication
(10) Pub. No.: US 2021/0255383 A1
(43) Pub. Date: Aug. 19, 2021

(54) OPTICAL DEVICE

(71) Applicant: Innolux Corporation, Miao-Li County (TW)

(72) Inventors: Chieh Ying Chen, Miao-Li County (TW); Ming Yen Lin, Miao-Li County (TW); Chun Hsu Lin, Miao-Li County (TW); Hsin-Yi Huang, Miao-Li County (TW); Shu Hua Wu, Miao-Li County (TW)

(73) Assignee: Innolux Corporation, Miao-Li County (TW)

(21) Appl. No.: 17/159,170

(22) Filed: Jan. 27, 2021

(30) Foreign Application Priority Data
Feb. 13, 2020 (CN) 202010091109.6

(51) Int. Cl. F21V 8/00

(52) U.S. Cl. CPC G02B 6/0051; G02B 6/0053; G02B 6/0073

(57) ABSTRACT

The disclosure provides an optical device including a diffusion layer, a light-emitting device, and a first photoluminescent film. The diffusion layer is disposed opposite to the light-emitting device, and the light-emitting device includes a plurality of light-emitting units. The first photoluminescent film is between the diffusion layer and the light-emitting device. A first distance between the first photoluminescent film and the diffusion layer is greater than a second distance between the first photoluminescent film and one of the plurality of light-emitting units. The optical device of the disclosure may improve brightness efficiency.

### CROSS-REFERENCE TO RELATED APPLICATION

This application claims the priority benefit of China application serial no. 202010091109.6, filed on Feb. 13, 2020. The entirety of the above-mentioned patent application is hereby incorporated by reference herein and made a part of this specification.

### TECHNICAL FIELD

The disclosure relates to an optical device with a photoluminescent film.

### BACKGROUND

In recent years, in order to pursue higher color saturation, display devices have been adopting photoluminescent films as backlight sources. However, if blue light enters a photoluminescent film after energy is attenuated via a diffusion layer, backlight efficiency may be insufficient. In addition, the generally needed photoluminescent film has the same size as the panel. As the width of the photoluminescent film becomes larger, manufacturing cost is increased, and the larger the size, the more difficult the manufacture, resulting in a decrease in production yield.

### SUMMARY

The disclosure provides an optical device that may improve brightness efficiency.

According to an embodiment of the disclosure, an optical device includes a diffusion layer, a light-emitting device, and a first photoluminescent film. The diffusion layer is disposed opposite to the light-emitting device, and the light-emitting device includes a plurality of light-emitting units. The first photoluminescent film is between the diffusion layer and the light-emitting device. A first distance between the first photoluminescent film and the diffusion layer is greater than a second distance between the first photoluminescent film and one of the plurality of light-emitting units.

Based on the above, in an embodiment of the disclosure, the first distance between the first photoluminescent film and the diffusion layer is greater than the second distance between the first photoluminescent film and one of the plurality of light-emitting units, and therefore, brightness efficiency may be improved.

In order to make the above features and advantages of the disclosure better understood, embodiments are specifically provided below with reference to figures for detailed description as follows.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a cross-sectional view of an optical device of an embodiment of the disclosure.

FIG. 2 is a diagram of the transmission spectrum of a diffusion layer under different light sources.

FIG. 3 is a diagram of the light energy of blue light first exciting a photoluminescent film and then transmitting a diffusion layer.

FIG. 4 is a cross-sectional view of an optical device of another embodiment of the disclosure.

FIG. 5 is a top view of an optical device of yet another embodiment of the disclosure.

FIG. 6 and FIG. 7 are cross-sectional views corresponding to section line A-A′ in FIG. 5.

### DETAILED DESCRIPTION OF DISCLOSED EMBODIMENTS

The disclosure may be understood by referring to the following detailed description in conjunction with the accompanying figures. It should be noted that, in order to facilitate the reader's understanding and the conciseness of the figures, the multiple figures in the disclosure depict a portion of the optical device/light-emitting device, and specific elements in the figures are not drawn according to actual scale. In addition, the number and size of each element in the figures are for illustration, and are not intended to limit the scope of the disclosure. For example, for clarity, the relative size, thickness, and position of each region and/or structure may be reduced or enlarged.

Certain terms are used throughout the specification and the appended claims of the disclosure to refer to particular elements. Those skilled in the art should understand that electronic equipment manufacturers may refer to the same elements under different names. The present specification is not intended to distinguish between elements having the same function but different names. In the following description and claims, the words “having” and “including” and the like are open words, so they should be interpreted as meaning “including but not limited to . . . ”

The terminology mentioned in the specification, such as: “up”, “down”, “front”, “rear”, “left”, “right”, etc., are directions referring to the figures. Therefore, the directional terms used are used for illustration, not for limiting the disclosure. It should be understood that when an element or film layer is referred to as disposed “on” or “connected” to another element or film layer, the element or film layer may be directly on the other element or film layer or directly connected to the other element or film layer, or there is an inserted element or film layer between the two (indirect case). Conversely, when an element or film layer is referred to as “directly” on or “directly connected” to another element or film layer, there is no intervening element or film layer between the two.

The term “about” or “substantially” mentioned in the specification usually means falling within 10% of a given value or range, or means falling within 5%, 3%, 2%, 1%, or 0.5% of a given value or range. In addition, the phrases “a given range is from a first numerical value to a second numerical value” and “a given range falls within the range of a first numerical value to a second numerical value” mean that the given range contains the first numerical value, the second numerical value, and other values in between.

In some embodiments of the disclosure, terms such as “connection”, “interconnection”, etc. regarding bonding and connection, unless specifically defined, may mean that two structures are in direct contact, or that two structures are not in direct contact and there are other structures located between these two structures. The terms of bonding and connection may also include the case where both structures are movable or both structures are fixed.

In the following embodiments, the same or similar elements adopt the same or similar reference numerals and are not described again. In addition, the features in different embodiments may be mixed and matched arbitrarily as long as they do not violate the spirit of the disclosure or conflict with each other, and simple equivalent changes and modifications made in accordance with the specification or claims still fall within the scope of the disclosure. In addition, terms such as “first” and “second” mentioned in the specification or claims are used to name discrete elements or to distinguish different embodiments or ranges, and are not used to limit the upper limit or the lower limit of the number of elements and are also not used to limit the manufacturing order or arrangement order of the elements.

In the disclosure, the various embodiments described below may be mixed and matched without departing from the spirit and scope of the disclosure. For example, some features of an embodiment may be combined with some features of another embodiment to form another embodiment.

Hereinafter, reference will be made in detail to exemplary embodiments of the disclosure, and examples of the exemplary embodiments are illustrated in the figures. Wherever possible, the same reference numerals are used in the figures and the descriptions to refer to the same or similar portions.

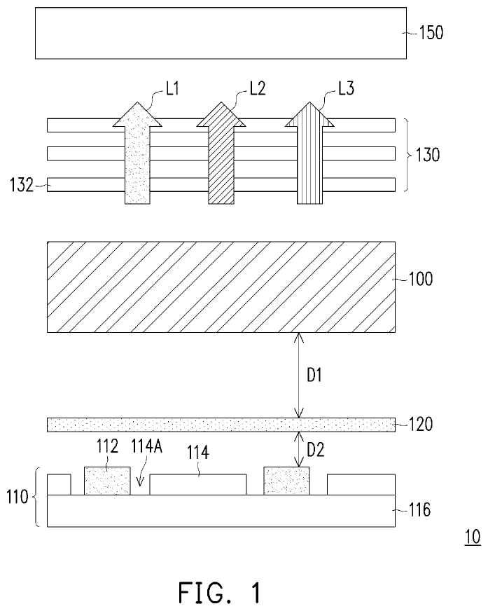

FIG. 1 is a cross-sectional view of an optical device of an embodiment of the disclosure.

Referring to FIG. 1, an optical device 10 may include a diffusion layer 100, a light-emitting device 110, a photoluminescent film 120, an optical film layer 130, and a panel 150. The diffusion layer 100 is disposed opposite to the light-emitting device 110, and the diffusion layer 100 may include a polystyrene (PS) diffusion layer or other flat plates made of diffusible light source materials. The light-emitting device 110 may include a plurality of light-emitting units 112 and a reflective sheet 114 disposed on a circuit substrate 116. The reflective sheet 114 may have a plurality of openings 114A respectively corresponding to the plurality of light-emitting units 112 and exposing the plurality of light-emitting units 112. The circuit substrate 116 may be a printed circuit board (PCB) or other wired boards. The substrate of the circuit substrate may be, for example, a flexible substrate or a rigid substrate. The material of the substrate may include, for example, polyimide (PI), a glass substrate, or other materials suitable as a substrate. The light-emitting units 112 may include, for example, light-emitting diodes (LEDs), and the LEDs may include, for example, organic light-emitting diodes (OLEDs), mini LEDs, micro LEDs, or quantum dot LEDs (may include QLEDs, QDLEDs). In an embodiment, a second lens may be covered on the LEDs. However, the disclosure is not limited thereto.

The photoluminescent film 120 is disposed between the diffusion layer 100 and the light-emitting device 110. There is a first distance D1 between the photoluminescent film 120 and the diffusion layer 100, and there is a second distance D2 between the photoluminescent film 120 and one of the plurality of light-emitting units 112, wherein the first distance D1 is greater than the second distance D2. In other words, compared to the diffusion layer 100, the photoluminescent film 120 is closer to the light-emitting device 110. The first distance D1 between the photoluminescent film 120 and the diffusion layer 100 may be, for example, the shortest distance between the photoluminescent film 120 and the diffusion layer 100. However, the disclosure is not limited thereto. In an embodiment, the first distance D1 between the photoluminescent film 120 and the diffusion layer 100 may be, for example, in a range from 5 mm to 30 mm (5 mm≤D1≤30 mm), in a range from 10 mm to 25 mm (10 mm≤D1≤25 mm), or in a range from 15 mm to 20 mm (15 mm≤D1≤20 mm), but the disclosure is not limited thereto. The second distance D2 between the photoluminescent film 120 and one of the plurality of light-emitting units 112 may be, for example, the shortest distance between the photoluminescent film 120 and one of the plurality of light-emitting units 112. However, the disclosure is not limited thereto. In an embodiment, the second distance D2 between the photoluminescent film 120 and one of the plurality of light-emitting units 112 may be, for example, in a range from 0.05 mm to 5 mm (0.05 mm≤D2≤5 mm), in a range from 0.1 mm to 4 mm (0.1 mm≤D1≤4 mm), or in a range from 0.2 mm to 3 mm (0.2 mm≤D1≤3 mm), but the disclosure is not limited thereto. In the above embodiments, the range of the ratio D1/D2 of the first distance D1 to the second distance D2 may be, for example, in a range from 10 to 600 (10≤D1/D2≤600). However, the disclosure is not limited thereto. Moreover, in some embodiments, the photoluminescent film 120 may be disposed on at least two of the plurality of light-emitting units 112 via, for example, a hanging ear or a support pin (not shown). As a result, the effect of facilitating heavy work may be provided. The hanging ear, for example, may be used to support or fix the photoluminescent film 120 and the photoluminescent film 120 may be hung on at least two of the plurality of light-emitting units 112. The support pin may also be used to support or fix the photoluminescent film 120, for example.

In some other embodiments, the photoluminescent film 120 may be directly disposed on one of the plurality of light-emitting units 112, that is to said, the second distance D2 may be, for example, about 0 mm. However, the disclosure is not limited thereto. The photoluminescent film 120 may include, for example, a quantum dot (QD) thin film, an inorganic phosphor thin film, an organic phosphor thin film, an inorganic dye thin film, an organic dye thin film, or permutations and combinations of the above. However, the disclosure is not limited thereto. In some other embodiments, the optical film layer 130 is disposed at another side of the diffusion layer 100 opposite to the photoluminescent film 120, and the optical film layer 130 is between the diffusion layer 100 and the panel 150. However, the disclosure is not limited thereto. The optical film layer 130 may include at least one optical film 132.

However, the disclosure is not limited thereto. The optical film 132 may include, for example, a reflective dual brightness enhancement film (DBEF), a prism sheet, a diffuser film, or an optical composite film layer such as DPP1 (DBEF+prism+prism), DPP2 (diffuser+prism+prism), POP (prism on prism). However, the disclosure is not limited thereto.

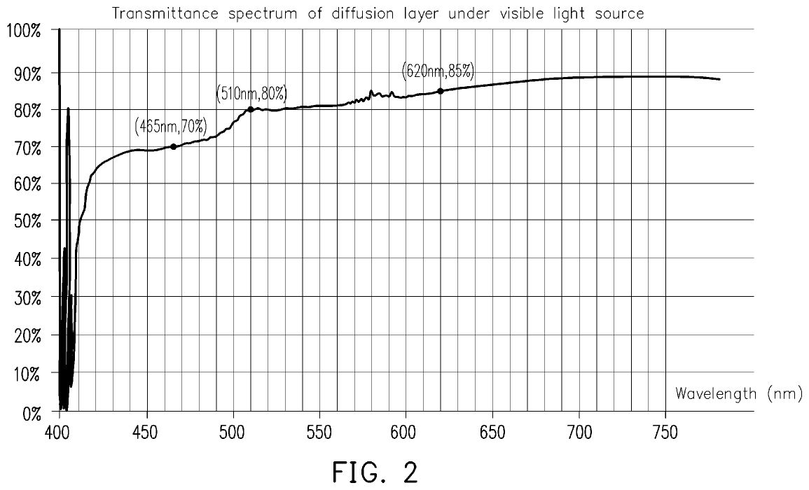

FIG. 2 is a diagram of the transmission spectrum of a diffusion layer under a visible light source. Generally speaking, red light is in a wavelength range from 600 nm to 700 nm, green light is in a wavelength range from 500 nm to 580 nm, and blue light is in a wavelength range from 420 nm to 480 nm. Referring to FIG. 2, compared to a transmittance to the diffusion layer of red light with a wavelength range from 600 nm to 700 nm or a transmittance to the diffusion layer of green light with a wavelength range from 500 nm to 580 nm, a transmittance to the diffusion layer of blue light with a wavelength range from 420 nm to 480 nm is lower. The diffusion layer tested in FIG. 2 is, for example, a polystyrene (PS) diffusion layer. However, the disclosure is not limited thereto. When other flat plates made of diffusible light source materials are used as the diffusion layer, similar results may also be measured.

Referring to FIG. 2, when the wavelength of blue light is, for example, about 465 nm, the transmittance of blue light may be, for example, about 70%. However, the disclosure is not limited thereto. When the wavelength of green light is, for example, about 510 nm, the transmittance of green light may be, for example, about 80%. However, the disclosure is not limited thereto. When the wavelength of red light is, for example, about 620 nm, the transmittance of red light may be, for example, about 85%. However, the disclosure is not limited thereto.

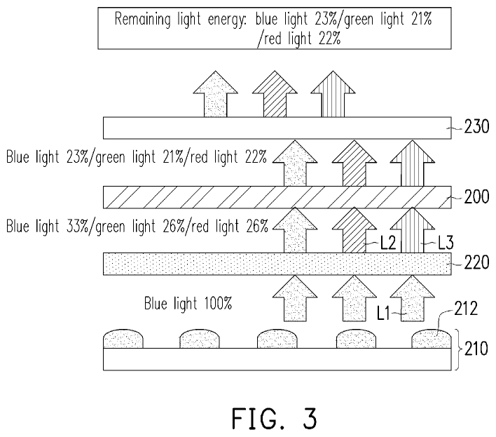

FIG. 3 is a diagram of the light energy of blue light first exciting a photoluminescent film and then transmitting a diffusion layer. Referring to FIG. 3, in some embodiments, a blue light L1 emitted by a plurality of light-emitting units 212 of a light-emitting device 210 first excites a photoluminescent film 220, and then transmits a diffusion layer 200. In other words, compared to the diffusion layer 200, the photoluminescent film 220 is closer to the light-emitting device 210. In more detail, referring to FIG. 3, the plurality of light-emitting units 212 may emit the blue light L1, and the light energy of the blue light L1 emitted by the plurality of light-emitting units 212 may be about 100%. Then, the blue light L1 first excites the photoluminescent film 220, and the photoluminescent film 220 is excited by the blue light L1 to generate a green light L2 and a red light L3. After the blue light L1 excites the photoluminescent film 220, the green light L2 and the red light L3 may respectively be, for example, about 33%. However, the disclosure is not limited thereto. The light conversion efficiency of the photoluminescent film may be, for example, about 80%. It should be noted that, the light energy of the blue light L1 after exciting the photoluminescent film 220 may be, for example, about 33%, the light energy of the green light L2 may be, for example, about 26%, and the light energy of the red light L3 may be, for example, about 26%, but the disclosure is not limited thereto. Next, after the blue light L1 excites the photoluminescent film 220, the green light L2, and the red light L3 transmit the diffusion layer 200. After transmitting the diffusion layer 200, the light energy of the blue light L1 is about 23%, the light energy of the green light L2 is about 21%, and the light energy of the red light L3 is about 22%. After transmitting the optical film 230, the remaining light energy of the blue light L1 is about 23%, the remaining light energy of the green light L2 is about 21%, and the remaining light energy of the red light L3 is about 22%. If the blue light first transmits the diffusion layer and then enters the photoluminescent film, the transmittance of the blue light L1 through the diffusion layer may be, for example, about less than 70% on average (as described in the related description of FIG. 2 above). After the blue light L1 transmits the diffusion layer 200, about 30% of the light energy is consumed before the blue light L1 is irradiated to the photoluminescent film 220, resulting in a decrease in brightness efficiency. Therefore, by first exciting the photoluminescent film before the blue light transmits the diffusion layer, an energy of overall output light may be increased when the photoluminescent film is closer to the light-emitting device than the diffusion layer.

Based on the related descriptions of FIG. 2 and FIG. 3 above, referring to the optical device 10 of the embodiment of the disclosure in FIG. 1, since the distance D1 between the photoluminescent film 120 and the diffusion layer 100 is greater than the distance D2 between the photoluminescent film 120 and one of the plurality of light-emitting units 112, that is to say, compared with the diffusion layer 100, the photoluminescent film 120 is closer to the light-emitting device 110. Therefore, the optical device 10 of the disclosure may help to increase an energy of overall output light and improve brightness efficiency.

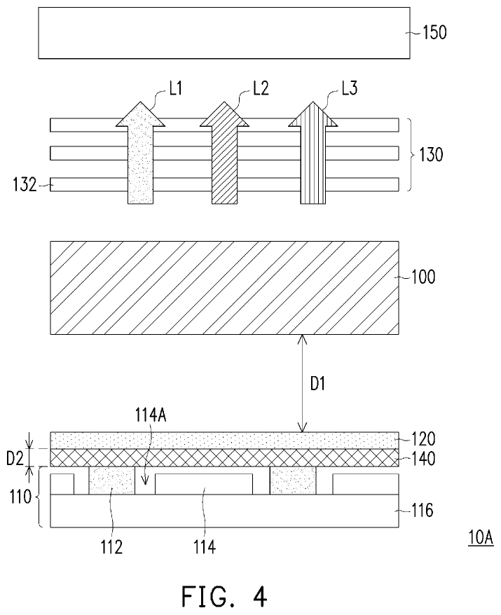

FIG. 4 is a cross-sectional view of an optical device of another embodiment of the disclosure. Referring to FIG. 4, an optical device 10A may include a diffusion layer 100, a light-emitting device 110, a photoluminescent film 120, an optical film layer 130, and a panel 150. The diffusion layer 100 is disposed opposite to the light-emitting device 110, and the diffusion layer 100 may include a polystyrene (PS) diffusion layer or other flat plates made of diffusible light source materials. The light-emitting device 110 may include a plurality of light-emitting units 112 and a reflective sheet 114 disposed on a circuit substrate 116. In details, the circuit substrate 116 is disposed opposite to the first photoluminescent film 120, and the plurality of light-emitting units 112 and the reflective sheet 114 are disposed between the first photoluminescent film 120 and the circuit substrate 116. The reflective sheet 114 may have a plurality of openings 114A respectively corresponding to the plurality of light-emitting units 112 and exposing the plurality of light-emitting units 112 (refer to FIG. 4). The circuit substrate 116 may be a printed circuit board (PCB) or other wired boards. The substrate of the circuit substrate may be, for example, a flexible substrate or a rigid substrate. The material of the substrate may include, for example, polyimide (PI), a glass substrate, or other materials suitable as a substrate. The light-emitting units 112 may include, for example, light-emitting diodes (LEDs), organic light-emitting diodes (OLEDs), mini LEDs, micro LEDs, or quantum dot LEDs (may include QLEDs, QDLEDs). In an embodiment, a second lens may be covered on the LEDs. However, the disclosure is not limited thereto.

The photoluminescent film 120 is between the diffusion layer 100 and the light-emitting device 110. The photoluminescent film 120 is fixed on at least two of the plurality of light-emitting units 112 via the adhesive layer 140. The light transmittance of the adhesive layer 140 is in a range from about 80% to 100%. The second distance D2 between the photoluminescent film 120 and one of the plurality of light-emitting units 112 may be, for example, the thickness of the adhesive layer 140, wherein the first distance D1 is greater than the second distance D2. Compared to the diffusion layer 100, the photoluminescent film 120 is closer to the light-emitting device 110. The first distance D1 between the photoluminescent film 120 and the diffusion layer 100 may be, for example, the shortest distance between the photoluminescent film 120 and the diffusion layer 100. However, the disclosure is not limited thereto. In an embodiment, the first distance D1 between the photoluminescent film 120 and the diffusion layer 100 may be, for example, in a range from 5 mm to 30 mm (5 mm≤D1≤30 mm), in a range from 10 mm to 25 mm (10 mm≤D1≤25 mm), or in a range from 15 mm to 20 mm (15 mm≤D1≤20 mm), but the disclosure is not limited thereto. The second distance D2 between the photoluminescent film 120 and one of the plurality of light-emitting units 112 may be, for example, the shortest distance between the photoluminescent film 120 and one of the plurality of light-emitting units 112. However, the disclosure is not limited thereto. In an embodiment, the second distance D2 between the photoluminescent film 120 and one of the plurality of light-emitting units 112 may be, for example, in a range from 0.05 mm to 5 mm (0.05 mm≤D2≤5 mm), in a range from 0.1 mm to 4 mm (0.1 mm≤D1≤4 mm), or in a range from 0.2 mm to 3 mm (0.2 mm≤D1≤3 mm), but the disclosure is not limited thereto. In the above embodiments, the range of the ratio D1/D2 of the first distance D1 to the second distance D2 may be, for example, in a range from 10 to 600 (10≤D1/D2≤600). However, the disclosure is not limited thereto. The material of the adhesive layer 140 may include, for example, silicon rubber, acrylic adhesive, thermosetting adhesive, UV light coating, or double-sided adhesive. However, the disclosure is not limited thereto. The adhesive layer 140 may be, for example, a single adhesive layer with the same size as the photoluminescent film 120, or a plurality of tiled adhesive layers. However, the disclosure is not limited thereto. In addition, the photoluminescent film 120 may be fixed on the surface of at least two of the plurality of light-emitting units 112, for example, via the adhesive layer 140, and may also be fixed on the second lens of at least two of the plurality of light-emitting units 112. The photoluminescent film 120 is fixed on at least two of the plurality of light-emitting units 112 via the adhesive layer 140 to provide a fixed and relatively flat effect. In some other embodiments, the optical film layer 130 is disposed at another side of the diffusion layer 100 opposite to the photoluminescent film 120, and is disposed between the diffusion layer 100 and the panel 150. However, the disclosure is not limited thereto.

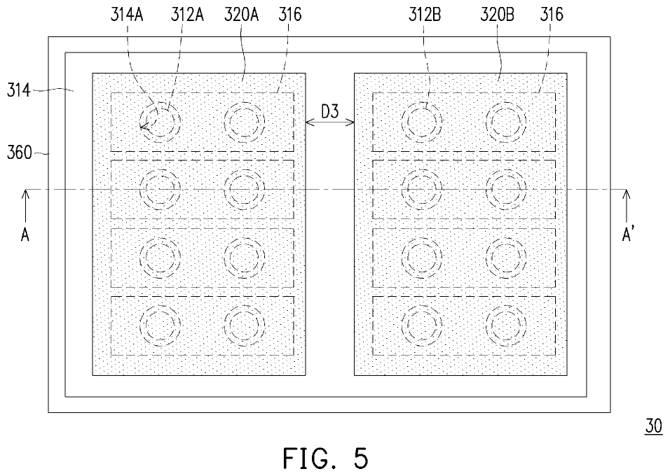

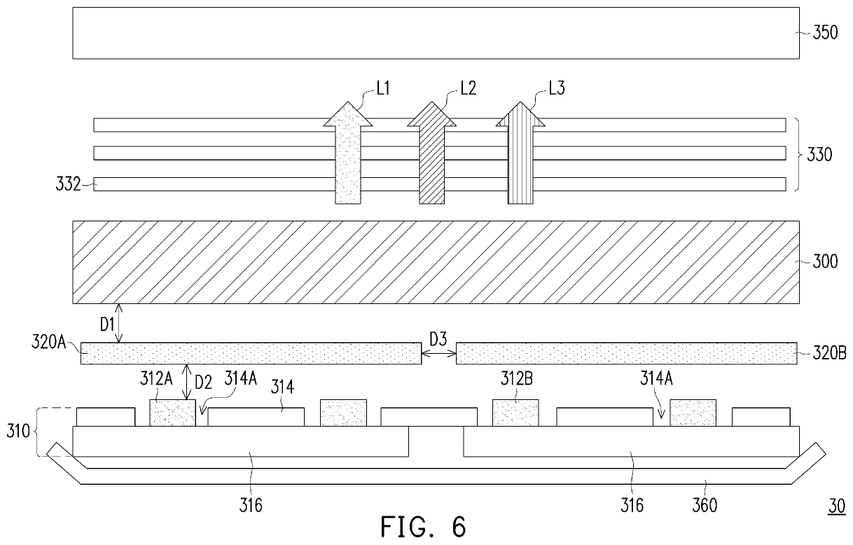

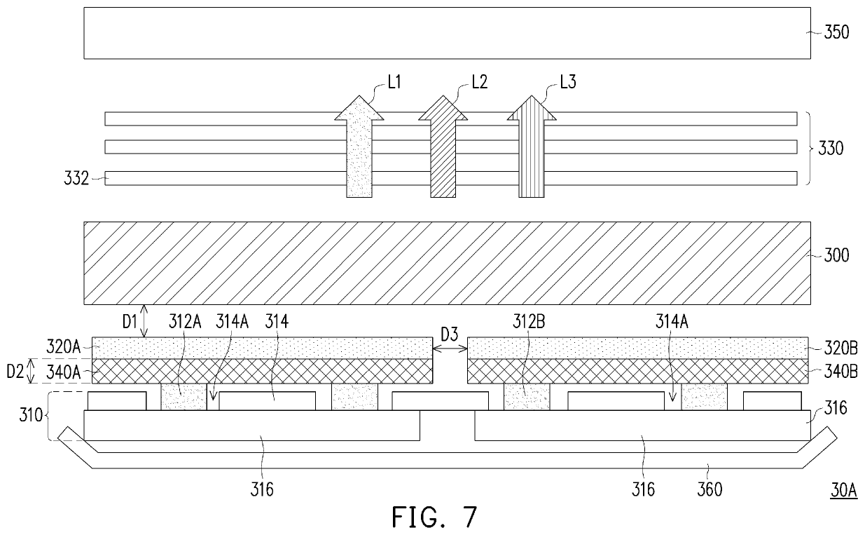

FIG. 5 is a top view of an optical device of yet another embodiment of the disclosure. FIG. 6 and FIG. 7 are cross-sectional views corresponding to section line A-A′ in FIG. 5. Referring to FIG. 5 and FIG. 6, an optical device 30 may include a diffusion layer 300, a light-emitting device 310, a first photoluminescent film 320A, a second photoluminescent film 320B, an optical film layer 330, a panel 350, and a back frame 360. It must be noted that, in order to clearly show a third distance D3 in FIG. 5, other layers such as the diffusion layer 300, the optical film layer 330, and the panel 350 are omitted. Referring to FIG. 6, the diffusion layer 300 is disposed opposite to the light-emitting device 310, and the diffusion layer 300 may include a polystyrene (PS) diffusion layer or other layers made of diffusible light source materials. The light-emitting device 310 may include a plurality of light-emitting units 312A and 312B and a reflective sheet 314 disposed on a circuit substrate 316. Referring to FIG. 5, the reflective sheet 314 may have a plurality of openings 314A respectively corresponding to the plurality of light-emitting units 312A and 312B and exposing the plurality of light-emitting units 312A and 312B. The circuit substrate 316 may be a printed circuit board (PCB) or other wired boards. The light-emitting units 312A and 312B may include, for example, light-emitting diodes (LEDs), organic light-emitting diodes (OLEDs), mini LEDs, micro LEDs, or quantum dot LEDs (may include QLEDs, QDLEDs), and a second lens may be covered on the LEDs. However, the disclosure is not limited thereto. Referring to FIG. 6, the optical film layer 330 includes at least one optical film layer 332, and the optical film 332 may include, for example, a reflective dual brightness enhancement film (DBEF), a prism sheet, a diffuser film, or an optical composite film layer such as DPP1 (DBEF+prism+prism), DPP2 (diffuser+prism+prism), POP (prism on prism). However, the disclosure is not limited thereto.

Referring to FIG. 5 and FIG. 6, the first photoluminescent film 320A and the second photoluminescent film 320B are between the diffusion layer 300 and the light-emitting device 310, the first photoluminescent film 320A is disposed on at least two of the plurality of light-emitting units 312A, and the second photoluminescent film 320B is disposed on at least two of the plurality of light-emitting units 312B. In other words, compared to the diffusion layer 300, the first photoluminescent film 320A and the second photoluminescent film 320B are closer to the light-emitting device 310. Therefore, the optical device 30 of the disclosure may increase an energy of overall output light and improve brightness efficiency. The first photoluminescent film 320A and the second photoluminescent film 320B may include, for example, quantum dot (QD) thin films, inorganic phosphor thin films, organic phosphor thin films, inorganic dye thin films, or organic dye thin films. However, the disclosure is not limited thereto. There is a first distance D1 between the first photoluminescent film 320A and the diffusion layer 300, and there is a second distance D2 between the first photoluminescent film 320A and one of the plurality of light-emitting units 312A, wherein the first distance D1 is greater than the second distance D2. In other words, compared to the diffusion layer 300, the first photoluminescent film 320A is closer to the light-emitting device 310. The first distance D1 between the first photoluminescent film 320A and the diffusion layer 300 may be, for example, the shortest distance between the first photoluminescent film 320A and the diffusion layer 300. However, the disclosure is not limited thereto. In some embodiment, the first distance D1 between the first photoluminescent film 320A and the diffusion layer 300 may be, for example, in a range from 5 mm to 30 mm (5 mm≤D1≤30 mm), in a range from 10 mm to 25 mm (10 mm≤D1≤25 mm), or in a range from 15 mm to 20 mm (15 mm≤D1≤20 mm), but the disclosure is not limited thereto. The second distance D2 between the first photoluminescent film 320A and one of the plurality of light-emitting units 312A may be, for example, the shortest distance between the first photoluminescent film 320A and one of the plurality of light-emitting units 312A. However, the disclosure is not limited thereto. The second distance D2 between the first photoluminescent film 320A and one of the plurality of light-emitting units 312A may be, for example, in a range from 0.05 mm to 5 mm (0.05 mm≤D2≤5 mm), in a range from 0.1 mm to 4 mm (0.1 mm≤D1≤4 mm), or in a range from 0.2 mm to 3 mm (0.2 mm≤D1≤3 mm), but the disclosure is not limited thereto. In the above embodiment, the range of the ratio D1/D2 of the first distance D1 to the second distance D2 may be, for example, in a range from 10 to 600 (10≤D1/D2≤600). However, the disclosure is not limited thereto. Moreover, in some embodiments, the photoluminescent film 320A may be disposed on at least two of the plurality of light-emitting units 312A via, for example, a hanging ear or a support pin (not shown). As a result, the effect of facilitating heavy work may be provided. The hanging ear, for example, may be used to support or fix the photoluminescent film 320A, and the photoluminescent film 320A may be hung on at least two of the plurality of light-emitting units 312A. The support pin may also be used to support or fix the photoluminescent film 320A, for example.

In some other embodiments, the first photoluminescent film 320A may be disposed on one of the plurality of light-emitting units 312A, and the second distance D2 may be, for example, about 0 mm. However, the disclosure is not limited thereto.

In some other embodiments, the first photoluminescent film 320A and the second photoluminescent film 320B may be disposed on the plurality of light-emitting units 312A and 312B in a tiling manner. The tiling method may include, for example, that the first photoluminescent film 320A is adjacent to the second photoluminescent film 320B, the first photoluminescent film 320A and the second photoluminescent film 320B are partially overlapped, or there is a third distance D3 between one edge of the first photoluminescent film 320A and another edge of the second photoluminescent film 320B, and the third distance D3 may be, for example, in a range from 0 mm to 2 mm (0 mm≤D3≤2 mm). However, the disclosure is not limited thereto. It should be noted that, the first distance D1 and the first distance D2 are measured along the normal direction of the panel 150, and the third distance D3 is measured perpendicular to the normal direction of the panel 150 in the disclosure.

In other words, although FIG. 5 and FIG. 6 show a tiling pattern with a gap (the third distance D3) between the first photoluminescent film 320A and the second photoluminescent film 320B, the disclosure is not limited thereto. The first photoluminescent film 320A may also be adjacent to the second photoluminescent film 320B, that is, the third distance D3 is zero (D3=0). Referring to FIG. 5 and FIG. 6, when there is the third distance D3 between the first photoluminescent film 320A and the second photoluminescent film 320B, the third distance may be the shortest distance between the first photoluminescent film 320A and the second photoluminescent film 320B, and the third distance D3 may be, for example, in a range from 0 mm to 2 mm (0 mm≤D3≤2 mm). However, the disclosure is not limited thereto. It must be noted that although two photoluminescent films (i.e., the first photoluminescent film 320A and the second photoluminescent film 320B) are shown in FIG. 5 and FIG. 6, the disclosure is not limited thereto, and the number of tiled photoluminescent films may be adjusted according to actual needs.

In some other embodiments, the first photoluminescent film 320A and the second photoluminescent film 320B may be disposed on the plurality of light-emitting units 312A and 312B in a tiling manner. The first photoluminescent film 320A and the second photoluminescent film 320B are partially overlapped. Referring to FIG. 5 and FIG. 6, when there is a third distance D3 between one edge of the first photoluminescent film 320A and another edge of the second photoluminescent film 320B, the third distance D3 may be the shortest distance where the first photoluminescent film 320A and the second photoluminescent film 320B are overlapped, and the third distance D3 may be, for example, greater than 0 mm and smaller and equal to 2 mm (0 mm<D3≤2 mm). However, the disclosure is not limited thereto. It must be noted that although two photoluminescent films (i.e., the first photoluminescent film 320A and the second photoluminescent film 320B) are shown in FIG. 5 and FIG. 6, the disclosure is not limited thereto, and the number of tiled photoluminescent films may be adjusted according to actual needs.

In addition, although it is shown in FIG. 6 that both the first photoluminescent film 320A and the second photoluminescent film 320B are disposed on the plurality of light-emitting units 312A and the plurality of light-emitting units 312B, the disclosure is not limited thereto. It may also be that one of the first photoluminescent film 320A and the second photoluminescent film 320B is disposed on the plurality of light-emitting units 312A or the plurality of light-emitting units 312B, and another one is fixed on the plurality of light-emitting units 312A or the plurality of light-emitting units 312B via an adhesive layer.

Referring to FIG. 7, in an optical device 30A of FIG. 7, further comprises a first adhesive layer 340A and a second adhesive layer 340B. The first adhesive layer 340A disposes between the first photoluminescent film 320A and the light-emitting device 310, otherwise, the second adhesive layer 340B disposes between the second photoluminescent film 320B and the light-emitting device 310. In other words, the first adhesive layer 340A disposes between the first photoluminescent film 320A and the plurality of light-emitting units 312A, otherwise, the second adhesive layer 340B disposes between the second photoluminescent film 320B and the plurality of light-emitting units 312B. That is to said, the first photoluminescent film 320A and the second photoluminescent film 320B may be fixed on the plurality of light-emitting units 312A and 312B via a first adhesive layer 340A and a second adhesive layer 340B. In more detail, the first photoluminescent film 320A may be fixed on at least two of the plurality of light-emitting units 312A via the first adhesive layer 340A, and the second photoluminescent film 320B may be fixed on at least two of the plurality of light-emitting units 312B via the second adhesive layer 340B. Compared to the diffusion layer 300, the first photoluminescent film 320B and the second photoluminescent film 320B are closer to the light-emitting device 310. In other words, the first distance D1 is greater than the second distance D2. The first distance D1 between the first photoluminescent film 320A and the second photoluminescent film 320B and the diffusion layer 300 may be, for example, the shortest distance between the first photoluminescent film 320A and the second photoluminescent film 320B and the diffusion layer 300. However, the disclosure is not limited thereto. In an embodiment, the first distance D1 between the first photoluminescent film 320A and the second photoluminescent film 320B and the diffusion layer 300 may be, for example, in a range from 5 mm to 30 mm (5 mm≤D1≤30 mm), in a range from 10 mm to 25 mm (10 mm≤D1≤25 mm), or in a range from 15 mm to 20 mm (15 mm≤D1≤20 mm), but the disclosure is not limited thereto. The second distance D2 between the first photoluminescent film 320A and the second photoluminescent film 320B and one of the plurality of light-emitting units 312A and 312B may be, for example, the thickness of the first adhesive layer 340A and the second adhesive layer 340B. However, the disclosure is not limited thereto. In an embodiment, the second distance D2 between the first photoluminescent film 320A and the second photoluminescent film 320B and one of the plurality of light-emitting units 312A and 312B may be, for example, in a range from 0.05 mm to 5 mm (0.05 mm≤D2≤5 mm), in a range from 0.1 mm to 4 mm (0.1 mm≤D1≤4 mm), or in a range from 0.2 mm to 3 mm (0.2 mm≤D1≤3 mm), but the disclosure is not limited thereto. In the above embodiments, the range of the ratio D1/D2 of the first distance D1 to the second distance D2 may be, for example, in a range from 10 to 600 (10≤D1/D2≤600). However, the disclosure is not limited thereto. The light transmittance of the first adhesive layer 340A and the second adhesive layer 340B is in a range from 80% to 100%. The materials of the first adhesive layer 340A and the second adhesive layer 340B may include, for example, silicon rubber, acrylic adhesive, thermosetting adhesive, UV light coating, or double-sided adhesive. However, the disclosure is not limited thereto. The first adhesive layer 340A and the second adhesive layer 340B may be single adhesive layers with the same size as the first photoluminescent film 320A and the second photoluminescent film 320B, respectively, as shown in FIG. 7, but are not limited thereto. The size of the first adhesive layer 340A and the size of the second adhesive layer 340B may be the same or different. However, the disclosure is not limited thereto. The size of the first photoluminescent film 320A and the size of the second photoluminescent film 320B may be the same or different. However, the disclosure is not limited thereto. The size of the first adhesive layer 340A and the size of the first photoluminescent film 320A may be the same or different. However, the disclosure is not limited thereto. The size of the second adhesive layer 340B and the size of the second photoluminescent film 320B may be the same or different. However, the disclosure is not limited thereto.

In some embodiments, the first adhesive layer 340A may be formed by combining a plurality of small-sized adhesive layers in a tiling manner, and the combined first adhesive layer 340A may be the same or different in size as the first photoluminescent film 320A. However, the disclosure is not limited thereto. The second adhesive layer 340B may be formed by combining a plurality of small-sized adhesive layers in a tiling manner, and the combined second adhesive layer 340B may be the same or different in size as the first photoluminescent film 320B. However, the disclosure is not limited thereto. In some other embodiments, the first adhesive layer 340A may be, for example, a single adhesive layer, and the second adhesive layer 340B may be, for example, a second adhesive layer formed by combining a plurality of small-sized adhesive layers in a tiling manner. However, the disclosure is not limited thereto. In addition, the first photoluminescent film 320A and the second photoluminescent film 320B may be, for example, fixed on the surfaces of the plurality of light-emitting units 312A and 312B via the first adhesive layer 340A and the second adhesive layer 340B, respectively, and may also be fixed on the second lens of the plurality of light-emitting units 312A and 312B. However, the disclosure is not limited thereto. The first photoluminescent film 320A and the second photoluminescent film 320B are fixed on the plurality of light-emitting units 312A and 312B via the first adhesive layer 340A and the second adhesive layer 340B, respectively, to provide a fixed and relatively flat effect.

It must be noted that although two photoluminescent films (i.e., the first photoluminescent film 320A and the second photoluminescent film 320B) and two adhesive layers (i.e., the first adhesive layer 340A and the second adhesive layer 340B) are shown in FIG. 7, the disclosure is not limited thereto, and the number of tiled photoluminescent films and adhesive layers may be adjusted according to actual needs. The first photoluminescent film 320A and the second photoluminescent film 320B may include, for example, quantum dot (QD) thin films, inorganic phosphor thin films, organic phosphor thin films, inorganic dye thin films, or organic dye thin films. However, the disclosure is not limited thereto. In some other embodiments, the optical film layer 330 is disposed at another side of the diffusion layer 300 opposite to the first photoluminescent film 320A and the second photoluminescent film 320B, and is disposed between the diffusion layer 300 and the panel 350. However, the disclosure is not limited thereto. The optical film layer 330 may include at least one optical film 332. However, the disclosure is not limited thereto. The optical film 332 may include, for example, a reflective dual brightness enhancement film (DBEF), a prism sheet, a diffuser film, or an optical composite film layer such as DPP1 (DBEF+prism+prism), DPP2 (diffuser+prism+prism), POP (prism on prism). However, the disclosure is not limited thereto.

Referring to FIG. 5, FIG. 6, and FIG. 7, by disposing the first photoluminescent film 320A and the second photoluminescent film 320B on the plurality of light-emitting units 312A and 312B in a tiling manner, a photoluminescent film needed for a super-large module (for example, 100 inches or 120 inches or above) may be provided. Therefore, the size limitation of the photoluminescent film may be solved, and the cost of providing an expensive super-large photoluminescent film may be saved, thus achieving the effects of reducing production costs and improving production yield and solving the issue of size limitation of the photoluminescent film. In more detail, by disposing the first photoluminescent film 320A and the second photoluminescent film 320B on the plurality of light-emitting units 312A and 312B in a tiling manner, the brightness may be increased, for example, by 5%. However, the disclosure is not limited thereto. In addition, in a tiling embodiment of the photoluminescent film, regardless of whether the tiling method of the first photoluminescent film 320A and the second photoluminescent film 320B is that the first photoluminescent film 320A is adjacent to the second photoluminescent film 320B, the first photoluminescent film 320A and the second photoluminescent film 320B are partially overlapped, or there is the distance D3 between the first photoluminescent film 320A and the second photoluminescent film 320B, the third distance D3 may be, for example, in a range from 0 mm to 2 mm (0 mm≤D3≤2 mm). However, the disclosure is not limited thereto. These three tiling methods may solve the seam issue in terms of the style of the tiling portion, thus improving the visual perception of the tiling portion and alleviating the issue of yellow band or blue band. The so-called yellow band means that if there is overlap at the junction of the photoluminescent film, the color of the light emitted from the overlapped portion is more yellow than the non-overlapped portion. The so-called blue band means that if there is a gap at the junction of the photoluminescent film, the color of the light emitted from the gap portion is bluer than the color of other portions.

Based on the above, in an embodiment of the disclosure, the first distance between the first photoluminescent film and the diffusion layer is greater than the second distance between the first photoluminescent film and one of the plurality of light-emitting units, and compared with the diffusion layer, the photoluminescent film is closer to the light-emitting device. Therefore, the optical device of the disclosure may increase an energy of overall output light and improve brightness efficiency. In more detail, compared to a transmittance to the diffusion layer of red light with a wavelength range from 600 nm to 700 nm or a transmittance to the diffusion layer of green light with a wavelength range from 500 nm to 580 nm, a transmittance to the diffusion layer of blue light with a wavelength range from 420 nm to 480 nm is lower. Therefore, in the disclosure, by bringing the photoluminescent film closer to the light-emitting device, the blue light emitted by the light-emitting units first excites the photoluminescent film, and then transmits the diffusion layer in order to solve the issue of reduced brightness efficiency caused by the diffusion layer having lower transmittance in the blue wave band.

In an embodiment, the photoluminescent film may be disposed on at least two of the plurality of light-emitting units via, for example, a hanging ear or a support pin. As a result, the effect of facilitating heavy work may be provided. In an embodiment, the photoluminescent film may be fixed on the surface of at least two of the plurality of light-emitting units via an adhesive layer, and may also be fixed on the second lens of at least two of the plurality of light-emitting units via an adhesive layer to provide a fixed and flattening effect. In an embodiment, a plurality of photoluminescent films may be disposed on the plurality of light-emitting units in a tiling manner. The tiling method may include, for example, that the plurality of photoluminescent films are adjacent to each other, the plurality of photoluminescent films are partially overlapped, or there is a gap between the plurality of photoluminescent films. In this way, a photoluminescent film needed by a super-large module may be provided. Therefore, the effect of reducing production cost and improving production yield may be provided, and the size limitation issue of the photoluminescent film may be solved. In addition, the plurality of photoluminescent films are disposed on the plurality of light-emitting units in a tiling manner, and since the photoluminescent films are closer to the light-emitting device, an energy of overall output light may be increased and brightness efficiency may be improved.

The above embodiments are used to describe the technical solution of the disclosure instead of limiting it. Although the disclosure has been described in detail with reference to each embodiment above, those having ordinary skill in the art should understand that the technical solution recited in each embodiment above may still be modified, or some or all of the technical features thereof may be equivalently replaced. These modifications or replacements do not make the essence of the corresponding technical solutions depart from the scope of the technical solution of each embodiment of the disclosure.

Although the embodiments of the disclosure and their advantages are disclosed as above, it should be understood that any person skilled in the art, without departing from the spirit and scope of the disclosure, may make changes, substitutions, and modifications, and features between the embodiments may be mixed and replaced at will to form other new embodiments. In addition, the scope of the disclosure is not limited to the manufacturing process, machinery, manufacture, material composition, device, method, and steps in a specific embodiment described in the specification. Any person skilled in the art may understand the current or future development process, machinery, manufacture, material composition, device, method, and steps from the content of the disclosure, which may all be adopted according to the disclosure as long as they may implement substantially the same function or obtain substantially the same result in an embodiment described here. Therefore, the scope of the disclosure includes the above manufacturing process, machinery, manufacture, material composition, device, method, and steps. In addition, each claim constitutes an individual embodiment, and the scope of the disclosure also includes the combination of each claim and embodiment. The scope of the disclosure shall be subject to the scope defined by the following claims.

What is claimed is:

1. An optical device, comprising:
a diffusion layer and a light-emitting device disposed opposite to the diffusion layer, wherein the light-emitting device comprises a plurality of light-emitting units; and
a first photoluminescent film disposed between the diffusion layer and the light-emitting device,
wherein a first distance between the first photoluminescent film and the diffusion layer is greater than a second distance between the first photoluminescent film and one of the plurality of light-emitting units.

2. The optical device of claim 1, wherein a ratio of the first distance to the second distance is in a range from 10 to 600.

3. The optical device of claim 1, wherein the first distance is in a range from 5 mm to 30 mm.

4. The optical device of claim 1, wherein the second distance is in a range from 0.05 mm to 5 mm.

5. The optical device of claim 1, wherein the first photoluminescent film is disposed on at least two of the plurality of light-emitting units.

6. The optical device of claim 1, further comprising :
a circuit substrate disposed opposite to the first photoluminescent film, wherein the plurality of light-emitting units are disposed between the circuit substrate and the first photoluminescent film.

7. The optical device of claim 6, wherein the light-emitting device comprises a reflective sheet disposed on the circuit substrate, the reflective sheet has a plurality of openings respectively corresponding to the plurality of light-emitting units and exposing the plurality of light-emitting units.

8. The optical device of claim 1, further comprising:
a first adhesive layer disposed between the first photoluminescent film and the light-emitting device, wherein the first photoluminescent film is fixed on the light-emitting device via the first adhesive layer.

9. The optical device of claim 8, wherein the second distance is a thickness of the first adhesive layer.

10. The optical device of claim 8, wherein a light transmittance of the first adhesive layer is in a range from 80% to 100%.

11. The optical device of claim 5, further comprising:
a second photoluminescent film disposed on at least two other of the plurality of light-emitting units.

12. The optical device of claim 11, further comprising:
a second adhesive layer disposed between the second photoluminescent film and at least two other of the plurality of light-emitting units, wherein the second photoluminescent film is fixed on at least two other of the plurality of light-emitting units via the second adhesive layer.

13. The optical device of claim 11, wherein the first photoluminescent film and the second photoluminescent film are partially overlapped.

14. The optical device of claim 11, wherein a third distance between the first photoluminescent film and the second photoluminescent film is in a range from 0 mm to 2 mm.

15. The optical device of claim 12, wherein the second distance is a thickness of the second adhesive layer.

16. The optical device of claim 12, wherein a light transmittance of the second adhesive layer is in a range from 80% to 100%.

17. The optical device of claim 1, further comprising:
an optical film layer, wherein the optical film layer is disposed at another side of the diffusion layer opposite to the first photoluminescent film .

18. The optical device of claim 17, further comprising:
a panel, wherein the optical film layer is disposed between the diffusion layer and the panel.

19. The optical device of claim 11, further comprising:
an optical film layer, wherein the optical film layer is disposed at another side of the diffusion layer opposite to the first photoluminescent film and the second photoluminescent film.

20. The optical device of claim 19, further comprising:
a panel, wherein the optical film layer is disposed between the diffusion layer and the panel.
